(19) United States
(12) Patent Application Publication
(10) Pub. No.: US 2021/0131812 A1
(43) Pub. Date: May 6, 2021

(54) SYSTEM AND METHOD FOR ROUTE BASED OPTIMIZATION FOR BATTERY ELECTRIC VEHICLES

(71) Applicant: FORD GLOBAL TECHNOLOGIES, LLC, Dearborn, MI (US)

(72) Inventors: Qiuming GONG, Novi, MI (US); Shuzhen LIU, Novi, MI (US)

(21) Appl. No.: 16/672,625

(22) Filed: Nov. 4, 2019

(51) Int. Cl. G01C 21/34; G01C 21/36

(52) U.S. Cl. CPC G01C 21/3407; G01C 21/3626; G01C 21/3469

(57) ABSTRACT

A system and method is disclosed for providing route guidance for an electric vehicle. The electric vehicle may use static traffic data (e.g., speed limit, traffic lights, stop signs) and non-static traffic data (e.g., vehicular accidents, road closures, construction) to calculate driving routes between a current location and a destination location. The driving routes may be adjusted to account for the ambient temperature external to the electric vehicle. The driving routes may also be adjusted to account for internal loads (e.g., air conditioning system or heating system) that may exhausted by the battery to the electric motor to propel the electric vehicle along the driving routes. A display unit may accentuate a target driving route that would require the least amount of power be expended by the battery.

### TECHNICAL FIELD

This disclosure relates to a battery electric vehicle (BEV) that may include a route optimization and planning algorithm to assist in reducing energy consumption.

### BACKGROUND

Battery electric vehicles (BEV) may include, a high-voltage (i.e., traction) battery that powers an electric motor for propulsion. While BEVs are increasing in popularity, the number and location of recharging stations is more limited as opposed to the number and location refueling stations for conventional gasoline engine vehicles. Navigation software is therefore relied on to assist BEV operators in selecting driving routes that may increase the operating range of the battery.

### SUMMARY

A system and method is disclosed for providing route guidance for an electric vehicle. The electric vehicle may include a battery that is operable to provide power to propel an electric motor. The electric vehicle may also include a navigation system operable to receive static traffic data (e.g., speed limit, traffic lights, stop signs) and non-static traffic data (e.g., vehicular accidents, road closures, construction) between a current location of the electric vehicle and a destination location of the electric vehicle. The navigation system may also receive the static traffic data and non-static traffic data from a remote device that wirelessly communicates with the controller.

The electric vehicle may also include a controller that is operable to calculate one or more driving routes between the current location and the destination location using the static traffic data and the non-static traffic data. The one or more driving routes may generally be selected to reduce the power (i.e., state of charge) expended by the battery to propel the electric motor between the current location and the destination location.

The controller may also be operable to adjust the one or more driving routes by comparing the one or more driving routes against one or more stored driving patterns. The driving patterns may be generated using one or more stored drive cycles (e.g., US06 Supplemental Federal Test Procedure, EPA Urban Dynamometer Driving Schedule/LA4 (UDDS), Highway Fuel Economy Driving Schedule (HWFET), New York City Cycle). In an alternative embodiment, the one or more stored driving patterns may be generated based on prior trips by the electric vehicle between the current location and the destination location. It is also contemplated that the one or more stored driving patterns may be representative of the one or more driving routes and may be used to adjust the one or more driving routes to further reduce the power expended by the battery to propel the electric motor between the current location and the destination location.

The controller may be operable to adjust the one or more driving routes by determining the power the battery will expend at an ambient temperature external to the electric vehicle. The controller may also be operable to adjust the one or more driving routes by determining the power the battery will expend to power an internal load (e.g., air conditioner system or heating system) to the electric vehicle when the electric vehicle is driven along the one or more driving routes.

The controller may further be operable to select a target driving route by determining which of the one or more driving routes would expend a minimum power from the battery to propel the electric motor between the current location and destination location. The controller may be operable to display the one or more driving routes on a display unit located within the electric vehicle and to accentuate the target driving route on the display unit.

### BRIEF DESCRIPTION OF THE DRAWINGS

FIG. 1 illustrates an exemplary topology of a battery electric vehicle (BEV);

FIG. 2 illustrates an exemplary graph of the driving range of the BEV at various vehicle speeds and ambient temperatures;

FIG. 3A illustrates an exemplary graph of operation of the BEV over selected drive cycles;

FIG. 3B illustrates an exemplary graph of the state of charge of the BEV battery over the selected drive cycles;

FIG. 4 illustrates an exemplary graph of the state of charge of the BEV battery based on ambient temperatures and usage of internal loads;

FIG. 5 illustrates a flow diagram of a route optimization and planning algorithm that may be implemented by a controller of the BEV; and

FIG. 6 illustrates various driving routes that may be selected by the route optimization and planning algorithm implemented by the controller of the BEV.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

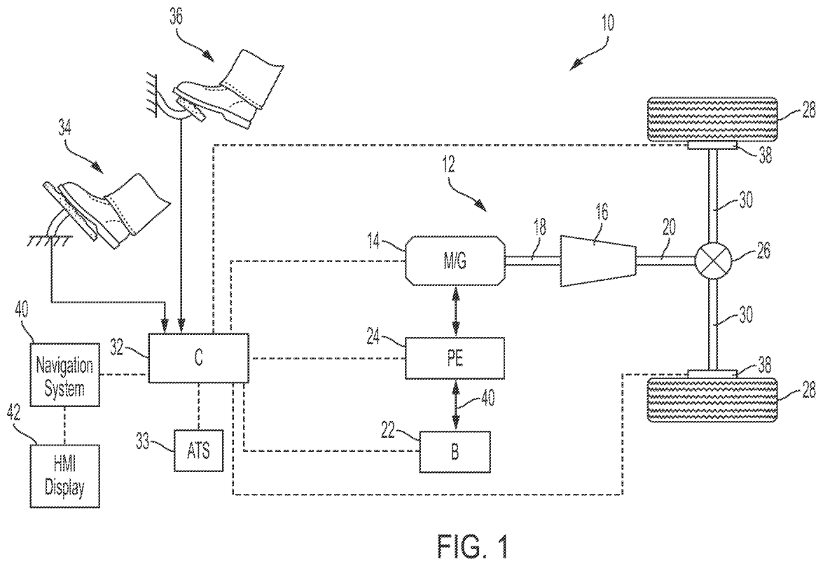

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an M/G 14 (i.e., electric motor/generator) that drives a transmission 16 (or gearbox). More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated battery 22 (i.e., high voltage battery) is configured to deliver electrical power to or receive electrical power from the M/G 14. Depending upon the type of electric vehicle 10, the size of the battery 22 may vary. For instance, the electric vehicle 10 may be configured such that the battery 22 may be sized to provide 400-Volts or 800-Volts.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the output shaft 20 and the input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the operating mode or condition.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the controller 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16.

Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, slowing or shift mode (MDE), battery temperature, voltage, current, or state of charge (SOC) for example.

It is also contemplated that controller 32 may communicate with and be provided navigation and/or route planning software from a navigation system 40 operable to acquire telematic information responsive to the location of the vehicle 10. For instance, the navigation system 40 may be operable to calculate route estimations using static traffic data that includes: (a) travel times along highway and local roads; (b) travel times based on traffic light locations; and (c) travel times based on speed limits for highway and local roads. The navigation system 40 may also be operable to calculate route estimations using non-static traffic data that includes: (a) vehicular accident alerts; (b) construction updates for highway and local roads; and (c) road closure data (e.g., road closure due to flooding). It is contemplated that such information could be provided using known systems (e.g., Google Maps, Waze, EnLighten). Or it is contemplated that navigation system may be connected to a remote server that transmits the static and non-static traffic data to vehicle using known wireless and/or cellular communication standards (e.g., 5G, 4G).

It is also contemplated that the navigation system 40 may be connected to an HMI display 42 (i.e., human-machine interface display) that is located within the cabin of a vehicle. HMI display 42 may also be connected to controller 32 for receiving user data inputs (e.g., desired route location) and to provide both visual and audible outputs to the user (e.g., potential routes and instructions). It is also contemplated that the navigation and route planning software may be stored within the memory of the controller 32. Alternatively, the navigation system 40 and/or HMI display may be a user device (e.g., a smart phone) that communicates with controller 32 through known communication links (e.g., Bluetooth or USB connections). If navigation system 40 is a user device, it is contemplated that the navigation and route planning software may be stored on the user device and the static and non-static traffic data may be provided to controller 32 through a communication link.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular strategy being used. Similarly, the order of processing is not necessarily required to achieve the features and advantages described within this specification but is provided for ease of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the application. When implemented in software, the control logic may be provided in one or more computer-readable storage devices or media having stored data representing code or instructions executed by a computer to control the vehicle or its subsystems. The computer-readable storage devices or media may include one or more known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the battery 22 transmits stored electrical energy through wiring 40 to the power electronics 24 that may include an inverter, for example. The power electronics 24 convert DC voltage from the battery 22 into AC voltage to be used by the M/G 14. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It is contemplated that the schematic illustrated in FIG. 1 is merely representative and is not intended to be limiting. Other configurations are contemplated without deviating from the scope of the disclosure. It is also contemplated that the vehicle configuration described is merely exemplary and is not intended to be limited.

For BEV vehicles driving range may be important to users due to the charging infrastructure not being as abundant as the number and/or location of gasoline stations currently available to refuel gasoline vehicles. Another reason driving range may be important is the amount of time currently required to recharge the batteries of BEVs as opposed to the time it takes to refuel vehicles propelled by gasoline engines. It is contemplated that to increase the driving range of BEVs between recharging, the driving pattern, ambient temperature, and internal electrical loads may account for how quickly the state of charge of the battery 22 is depleted. It is therefore desirable to provide route guidance that accounts for these factors to minimize energy consumption of the battery 22 between driving destinations.

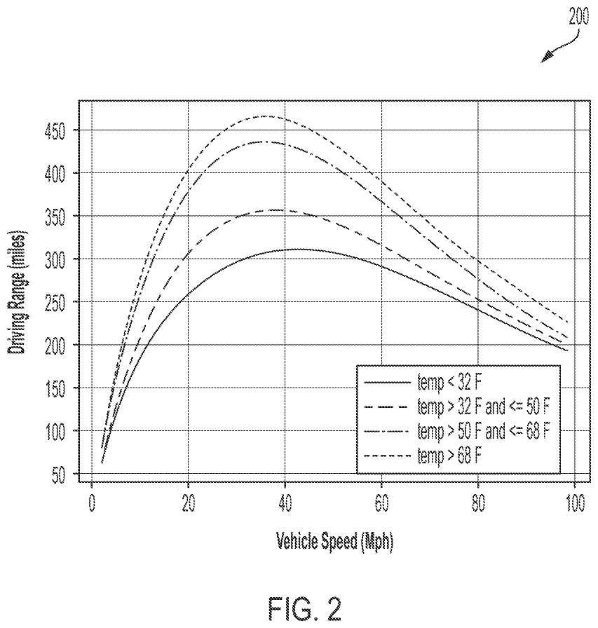

For instance, FIG. 2 is an exemplary discharge graph 200 expressed in terms of range (miles) at differing vehicle speeds. Graph 200 illustrates four discharge plots for vehicle 10 when: (a) the ambient temperature is less than or equal to 32 degrees Fahrenheit; (b) the ambient temperature is greater than 32 degrees Fahrenheit and less than or equal to 50 degrees Fahrenheit; (c) the ambient temperature is greater than 50 degrees Fahrenheit and less than or equal to 68 degrees Fahrenheit; and (d) the ambient temperature is greater than 68 degrees Fahrenheit. As illustrated for all four temperature plots, vehicle 10 may operate more efficiently when the vehicle speed is not too low (e.g., below 20 MPH) or too high (e.g., above 80 MPH). It is contemplated that if the vehicle speed can be maintained within a more efficient speed range (e.g., between 20 MPH and 80 MPH) the battery 22 may be able to provide vehicle 10 an extended driving range between recharges.

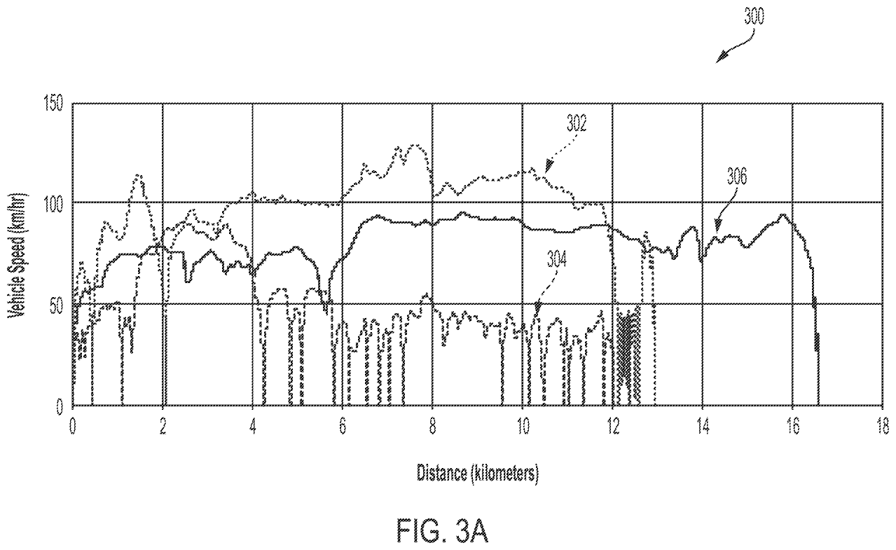

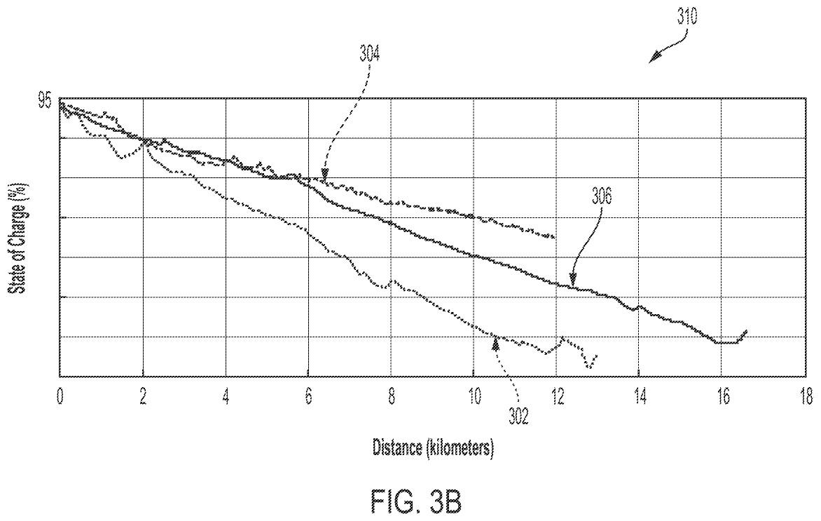

It is contemplated that simply assessing vehicle speed alone may not improve the driving range of vehicle 10. For instance, the driving range may be affected by: (a) the location where the vehicle 10 is driven (e.g., highway vs. city roads); (b) the terrain where the vehicle 10 is driven (e.g., hilly roads vs. flat roads); and (c) how aggressively the vehicle 10 is driven by the user (e.g., quick acceleration and braking actions). FIG. 3A illustrates a graph 300 where the vehicle 10 is driven at various vehicle speeds and distances along a first drive cycle 302, a second drive cycle 304, and a third drive cycle 306. For the first drive cycle 302, the vehicle 10 may be a more aggressive driving cycle that includes various terrains (e.g., hilly and flat), and a few vehicle start/stop conditions, and multiple adjustments to the vehicle speed. The second drive cycle 304 may represent the vehicle 10 being operated within a city (i.e., local) environment that includes multiple start/stop conditions due to stop signs and/or traffic lights. The third drive cycle 306 may represent the vehicle 10 being operated primarily within a highway environment that includes a substantially constant vehicle speed.

FIG. 3B illustrates a graph 310 where the state of charge of the battery 22 changes across the entire distances traveled for the first drive cycle 302, the second driving cycle 304, and the third driving cycle 306. As illustrated, during the first drive cycle 302 the state of charge of the battery 22 may be depleted at a higher rate than the second driving cycle 304 or third drive cycle 306. It is understood that the state of charge may be depleted at a quicker rate due to the terrain, changing vehicle speed, and start/stop conditions. Likewise, the second drive cycle 304 (i.e., city driving) the state of charge of the battery 22 may be depleted at a lower rate than the vehicle 10 being driven during the third drive cycle 306 (i.e., highway driving). Again, it is understood that the state of charge of the battery may be depleted at a lower rate during the second drive cycle 304 due to the vehicle 10 having to continually start and stop.

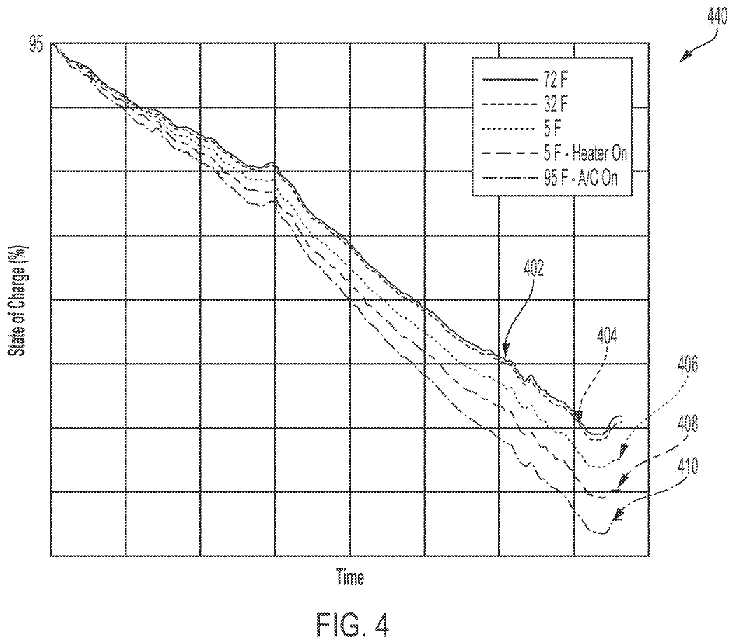

It is also contemplated that the driving range may be affected by: (a) the ambient temperature outside of the vehicle 10 or (b) the air-conditioning system or heating system of the vehicle 10 being operated. For instance, FIG. 4 illustrates a graph where the vehicle 10 is operated at various ambient temperatures (shown in degrees Fahrenheit). As shown, ambient temperature 402 may pertain to when the vehicle 10 is being operated at 73 degrees Fahrenheit. Ambient temperature 404 may pertain to when the vehicle 10 is being operated at 32 degrees Fahrenheit. Ambient temperature 406 may pertain to when the vehicle 10 is being operated at 5 degrees Fahrenheit. Ambient temperature 408 may pertain to when the vehicle 10 is being operated at 5 degrees Fahrenheit and the heating system is being operated to heat the vehicle cabin. Ambient temperature 410 may pertain to when the vehicle 10 is being operated at 95 degrees Fahrenheit and the air conditioning system is being operated to cool the vehicle cabin.

FIG. 4 illustrates that for ambient temperature 402 and 404, the state of charge of the battery 22 may be depleted at a substantially similar rate. Ambient temperature 402, 404 may indicate a desirable temperature operating range for the battery 22. It is contemplated that the desirable temperature operating range may be stored within the memory of the controller 32 and may be determined based on testing. Or, the temperature operating range may be determined by controller 32 based on the vehicle 10 being operated during a predefined number of cycles. For instance, the controller 32 may include a rolling average of drive cycles where the ambient temperature is sampled. Based on this rolling average, the controller 32 may begin to develop an operating table indicative of desirable range for the state of charge of the battery 22.

FIG. 4 also illustrates that for ambient temperature 406 the state of charge of the battery 22 may decline at a greater rate than ambient temperature 402, 404. It is understood that extreme cold and hot temperatures have a detrimental effect on the battery 22. It is therefore contemplated that the controller 32 may store an extreme temperature table indicative of ambient temperatures (e.g., ambient temperature 406) based on testing. Or it is again contemplated that the extreme temperature table may be developed by controller 32 based on vehicle usage and sampling of the battery 22 while the vehicle 10 is being operated.

For ambient temperature 408, it is contemplated that operation of the heater system within the vehicle 10 may deplete the state of charge of the battery 22 at a greater level than ambient temperature 406. For ambient temperature 410 the operation of the air conditioner system results in the greatest state of charge depletion for the battery 22. Controller 32 may be operable to account for internal loads within the vehicle 10 being activated and requiring energy from the battery 22 (e.g., heater system and air conditioner system). Controller 32 may also be operable to account for internal loads that may deplete the state of charge of the battery 22 at an increased rate (e.g., air conditioner system). Controller 32 may therefore be operable to adjust a target driving route that accounts for energy consumption based on the ambient temperature external to the vehicle 10 and operation of internal loads.

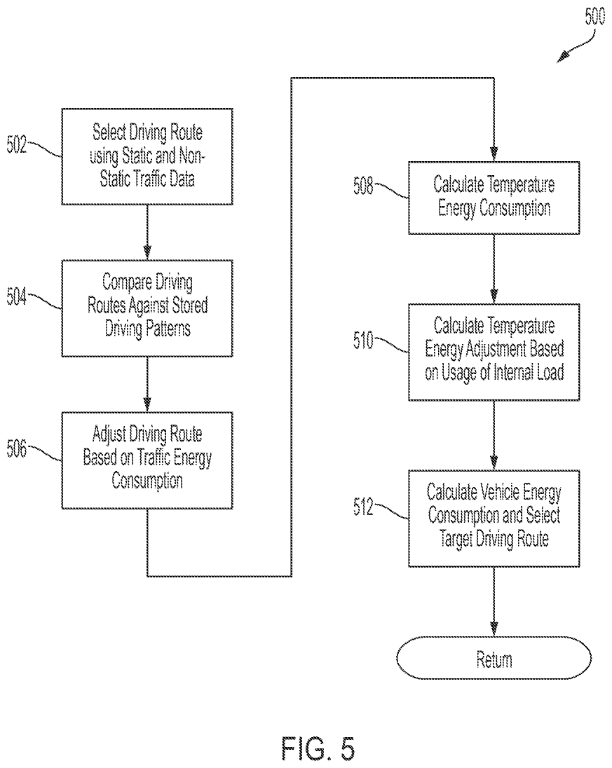

FIG. 5 illustrates a flow diagram 500 that may be implemented by controller 32 to provide route optimization and planning. Flow diagram 500 may be implemented by controller 32 to calculate a final vehicle energy consumption for a number of proposed driving routes and display a select number of routes on HMI display 42 that will allow the vehicle 10 to reach a selected destination with a reduced amount of energy being expended by the battery 22.

At step 502, the controller 32 may calculate a traffic energy consumption for a preset number of driving routes using static traffic data (e.g., travel times based on average speed limit, traffic lights) and non-static traffic data (e.g., traffic jam update, traffic accident update, road closure). Again, the static and non-static traffic data may be provided by navigation system 40 to the controller 32. Or, the controller 32 may receive the static and non-static traffic data from a system remote from the vehicle 10 using a wireless communication.

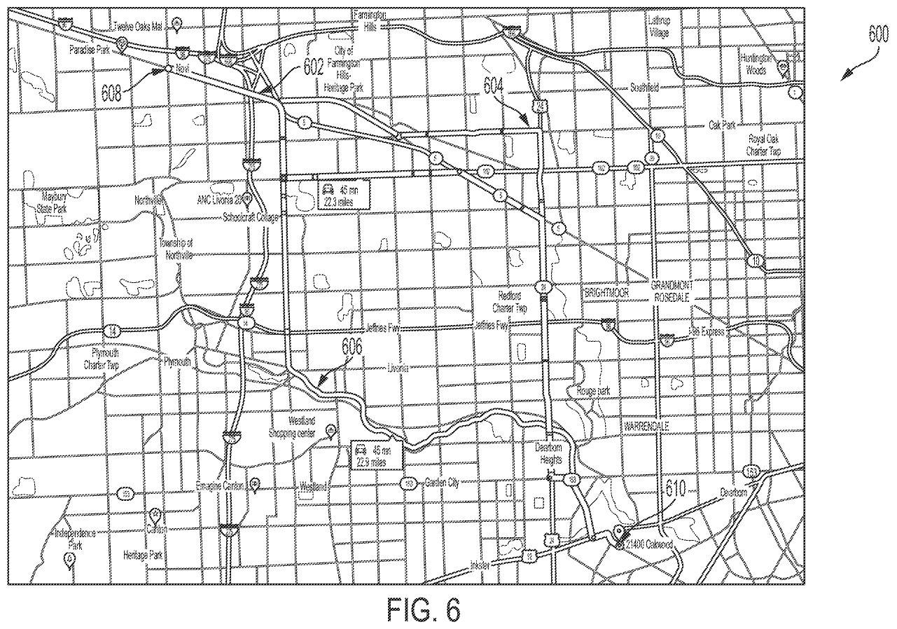

For instance, FIG. 6 illustrates a first driving route 602, second driving route 604, and third driving route 606 that may be illustrates a driving route for the vehicle 10 between a current destination 608 and final destination 610. The first driving route 602 may include operation of the vehicle 10 along a combination of city roads, as well as, highway roads. The second driving route 604 may primarily include operation of the vehicle 10 along highway roads. The third driving route 606 may primarily include operation of the vehicle 10 along city roads.

Based on the static traffic data and non-static traffic data, controller 32 may determine that the traffic energy consumption may be 8 kW for the third driving route 604 because there exists a traffic jam or accident where the vehicle 10 experience significant stop and go. Controller 32 may also determine the traffic energy consumption may be 10 kW for the third driving route 606 because there exists numerous stop-and-go driving conditions due to traffic lights and stop signals. Also, controller 32 may determine the traffic energy consumption may be 12 kW for the third driving route 606 because there exist numerous slowdowns due to congested traffic conditions. Controller 32 may therefore determine a selected driving route as being the first driving route 602 because it would require the lowest amount of energy being consumed by the battery 22.

It is also contemplated that the static traffic data and non-static traffic data may be compared with saved traffic patterns or data. For instance, controller 32 may be operable to store known or previous traffic patterns for a given driving route (e.g., first driving route 602). Or the controller may be operable to store data indicative of how long, or the amount of power that would be consumed by the battery along a given driving route (e.g., first driving route 602). The controller may then be able to determine the traffic energy consumption based on the saved traffic patterns or data.

At Step 504, the controller may adjust the traffic energy consumption based on a comparison between the selected driving route (e.g., first driving route 602) and prestored driving patterns. The prestored driving patterns may be saved in memory of the controller 32 based on known industry drive cycles (e.g., US06 Supplemental Federal Test Procedure, EPA Urban Dynamometer Driving Schedule/LA4 (UDDS), Highway Fuel Economy Driving Schedule (HWFET), New York City Cycle). For instance, the controller 32 may be operable to account for how the energy of the battery 22 may be depleted along the UDDS drive cycle which is exemplary of city driving conditions. Controller 32 may compare the third driving route 606 against the UDDS driving cycle to better account for how the energy of the battery 22 may be depleted during primarily city driving (i.e., how quickly the state of charge of the battery 22 may be depleted). Likewise, the controller 32 may be operable to account for how the energy of the battery 22 may be depleted along the HWFET drive cycle which is exemplary of highway driving conditions. Controller 32 may compare the second driving route 604 against the HWFET driving cycle to account for how the energy of the battery 22 may be depleted during primarily highway driving. Or the controller 32 may be operable to combine several drive cycles (e.g., UDDS and HFET) to account for how the energy of the battery 22 may be depleted during a combination of city driving and highway driving (e.g., first driving cycle 602).

Controller 32 may also generate and store the driving patterns based on operation of the vehicle 10 over time. For instance, the controller 32 may begin to generate known driving patterns for the vehicle 10 when operating between known destinations (e.g., work to home). If the vehicle 10 is routinely operated between the current destination 608 and final destination 610, the controller 32 may compare a generated driving pattern that accounts for energy depletion of the battery 22 against the known driving route.

At Step 506, the controller 32 may adjust the traffic energy consumption for each of the selected driving routes (e.g., driving routes 602, 604, 606) based on the comparison of the driving routes selected in Step 502 to the stored driving cycles. Controller 32 may further adjust a suggested driving route based on the comparison performed in step 504. For instance, controller 32 may have selected the first driving route 602 with a traffic energy consumption of 8 kW at step 502. Based on the comparison between the driving routes 602, 604, 606 and the stored driving cycles, controller 32 may calculate that the traffic energy consumption for the second driving route 604 (i.e., primarily city driving) may result in a lower traffic energy consumption (e.g., adjusted to 7 kW) than the first driving route 602 (e.g., adjusted to 9 kW). Controller 32 may therefore adjust the target driving route based on the calculated traffic energy adjustment as being the second driving route 604.

At Step 508, the controller 32 may receive an ambient temperature external to the vehicle 10. Controller 32 may receive the ambient temperature from data provided by ambient air temperature sensor 33. Or controller 32 may receive a wireless transmission providing the ambient temperature from a remote system. For instance, controller 32 may be operable to receive a cellular transmission providing ambient temperature. Or controller 32 may be operable to receive the ambient temperature from a device (e.g., cellular phone) located near or within the vehicle 10. Controller may then calculate a climate energy consumption that can be used to adjust the target driving route.

For instance, controller 32 may use received ambient temperature data or controller 32 may use a stored temperature table to calculate the climate energy estimation when the vehicle 10 is operated during extreme ambient temperatures (e.g., 5 degrees Fahrenheit or 95 degrees Fahrenheit). If the target driving route was selected as controller 32 may determine that the second driving route 604 (city driving) may require a high climate energy consumption because the battery 22 will be exposed for a greater period to the extreme ambient temperatures. Controller 32 may therefore again adjust the target driving route to ensure that the battery 22 is not exposed to long durations of extreme ambient temperatures. Controller 32 may adjust and select the third driving route 606 (i.e., primarily highway driving) as the target driving route to reduce the amount of time the battery 22 is exposed to the extreme ambient temperatures. By adjusting the target driving route, controller 32 may reduce the amount of energy that would be consumed by battery 22 during the extreme ambient temperatures.

At Step 510, controller 32 may calculate a climate energy adjustment that accounts for internal vehicle loads on the battery 22 and again adjust the target driving route. Again, controller 32 may be operable to account for internal loads within the vehicle 10 being activated that expend energy from the battery 22 (e.g., heater system and air conditioner system). Controller 32 may be operable to account for internal loads that may deplete the state of charge of the battery 22 at an increased rate (e.g., air conditioner system). For instance, the controller may be able to calculate how much energy would be need for an internal load (e.g., air conditioner) that would be operated due to the ambient temperature. Controller 32 may determine that when the ambient temperature is 85 degrees Fahrenheit, the internal load of operating the entire air conditioning system (including power to drive the fans) may be 3 kW. Controller 32 may therefore be operable to calculate the climate energy adjustment that further accounts for the internal loads that may consume energy from the battery 22. Particularly, the controller 32 may calculate the climate energy adjustment to account for internal loads that would be operational during warm ambient temperatures (e.g., heater system) or cold ambient temperatures (e.g., air conditioning system).

Controller 32 may then determine (and possibly adjust) the target driving route to account for a final energy consumption. It is contemplated that the final energy consumption for each of the driving routes 602, 604, 606 and the selected target driving route may be a trade-off between the static and non-static traffic data, driving cycle adjustment, ambient temperature adjustment, and the internal loads. For instance, driving route 604 (city driving) may generally consume less energy, but the long driving time due to low speed and continual start/stop conditions may increase the climate energy consumption during either extreme hot or cold ambient temperatures. Controller 32 may therefore be operable to continually calculate the final energy consumption to account for each of these factors and to select the target driving route that would result in the least amount of energy being consumed by the battery 22.

It is contemplated that minimization of the energy consumed by the battery 22 during operation of a BEV is desirable due to the limited number of charging stations and time currently required to recharge the battery 22. By calculating the energy consumption rates for the static and non-static traffic data, driving cycle adjustment, ambient temperature adjustment, and the internal loads, controller 32 may be able to calculate a target driving route that increases the driving range of the vehicle (i.e., decreases the amount of energy being consumed by the battery 22). The target driving route may be useful in conditions where the battery 22 is already depleted by a given amount (e.g., SOC=50%) and the vehicle 10 is being driven in extreme cold ambient temperatures. Lastly, it is contemplated that the various energy consumption rates can be pre-calculated from simulation models, collected from testing data performed on vehicle 10, or during operation of the vehicle 10.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A route planning system, comprising:
an electric motor operable to propel an electric vehicle;
a traction battery operable to provide power to drive the electric motor; and
a navigation system including one or more controllers operable to
generate a plurality of driving routes between an origin location and destination location using static data defined by speed limits of roads of the plurality of driving routes, and dynamic data defined by traffic on one or more roads,
generate for each of the plurality of driving routes a power consumption estimate from the traction battery to travel from the origin location to the destination location based on expected speed profile data for the plurality of driving routes and an ambient temperature along the plurality of driving routes such that the power consumption estimate is higher responsive to the ambient temperature being greater or less than a predefined range of temperatures and lower responsive to the ambient temperature being within the predefined range of temperatures,
select a target route having a minimum value of the power consumption estimate from the plurality of driving routes, and
display the target route.

2. The route planning system of claim 1, wherein the navigation system is further operable to adjust the target route based on a current state of charge of the traction battery.

3. The route planning system of claim 1, wherein navigation system is further operable to compare the plurality of driving routes against a plurality of driving cycles, and the target route is further adjusted to limit a state of charge expended by the traction battery to propel the electric motor between the origin location and the destination location.

4. The route planning system of claim 3, wherein the plurality of driving cycles is generated based on prior trips by the electric vehicle between the origin location and the destination location.

5. The route planning system of claim 1, wherein navigation system is further operable to adjust the target route based on an internal power consumption by an internal load within the electric vehicle.

6. The route planning system of claim 5, wherein the internal load includes a heating system.

7. The route planning system of claim 6, wherein the internal load includes an air conditioner system.

8. The route planning system of claim 1, wherein the static data includes a travel time based on a speed limit and one or more traffic lights between the origin location and destination location of the electric vehicle.

9. The route planning system of claim 1, wherein the dynamic data includes a travel time based on a traffic slowdown between the origin location and the destination location of the electric vehicle.

10. The route planning system of claim 9, wherein the traffic slowdown comprises a vehicular accident between the origin location and the destination location of the electric vehicle.

11. The route planning system of claim 9, wherein the traffic slowdown comprises a road closure between the origin location and the destination location of the electric vehicle.

12. The route planning system of claim 1, wherein the navigation system wirelessly receives the static data and dynamic data.

13. A route planning method, comprising:
calculating one or more driving routes between a current location and a destination location using static traffic data and non-static traffic data, wherein the one or more driving routes are calculated to reduce a power expended by a battery to propel an electric motor within an electric vehicle between the current location and the destination location;
adjusting the one or more driving routes by comparing the one or more driving routes against one or more stored driving patterns, wherein the one or more stored driving patterns are representative of the one or more driving routes, and wherein the one or more driving routes are adjusted to further reduce the power expended by the battery to propel the electric motor between the current location and the destination location;
adjusting the one or more driving routes by determining the power the battery will expend at an ambient temperature external to the electric vehicle and the power the battery will expend to power an internal load to the electric vehicle when the electric vehicle is driven along the one or more driving routes; and
displaying the one or more driving routes on a display unit located within the electric vehicle.

14. The route planning method of claim 13, further comprising:
selecting a target driving route by determining which of the one or more driving routes would expend a minimum power from the battery to propel the electric motor between the current location and destination location; and
accentuating the target driving route on the display unit.

15. The route planning method of claim 14, further comprising: adjusting the target driving route based on a current state of charge of the battery.

16. The route planning method of claim 13, further comprising: generating the one or more driving patterns using one or more stored drive cycles.

17. The route planning method of claim 13, further comprising generating the one or more stored driving patterns using one or more prior trips driven by the electric vehicle between the current location and the destination location.

18. The route planning method of claim 13, wherein the static traffic data includes a travel time based on a speed limit and one or more traffic lights between the current location and destination location of the electric vehicle.

19. The route planning method of claim 13, wherein the non-static traffic data includes a travel time based on a traffic slowdown between the current location and the destination location of the electric vehicle.

20. A route planning system, comprising:
a controller operable to:
receive a state of charge for a battery within an electric vehicle;
receive static traffic data and non-static traffic data;
calculate one or more driving routes for the electric vehicle between a current location and a destination location using the static traffic data and the non-static traffic data, wherein the one or more driving routes are compared against one or more traffic patterns to limit the state of charge expended by the battery to propel an electric motor between the current location and the destination location;
adjust the one or more driving routes by comparing the one or more driving routes against one or more stored driving cycles, wherein the one or more stored driving cycles are representative of the one or more driving routes, and wherein the one or more driving routes are adjusted to further limit the state of charge expended by the battery to propel the electric motor between the current location and the destination location;
adjust the one or more driving routes by determining the state of charge the battery will expend at an ambient temperature external to the electric vehicle and the state of charge the battery will expend to power an internal load to the electric vehicle when the electric vehicle is driven along the one or more driving routes; and
display the one or more driving routes on a display unit located within the electric vehicle.
